(19) United States
(12) Patent Application Publication
(10) Pub. No.: US 2026/0184947 A1
(43) Pub. Date: Jul. 2, 2026

(54) Ink Jet Composition Ink Set, Ink Jet Recording Method, And Ink Jet Recording Apparatus

(71) Applicant: SEIKO EPSON CORPORATION, Tokyo (JP)

(72) Inventor: Ryota MIYASA, Matsumoto (JP)

(21) Appl. No.: 19/433,364

(22) Filed: Dec. 26, 2025

(30) Foreign Application Priority Data
Dec. 27, 2024 (JP) 2024-231560

(51) Int. Cl. C09D 11/54; B41J 2/21; B41J 3/407; B41J 11/00; C09D 11/17; C09D 11/38; D06P 5/30

(52) U.S. Cl. CPC C09D 11/54; B41J 2/2114; B41J 3/4078; B41J 11/0015; C09D 11/17; C09D 11/38; D06P 5/30

(57) ABSTRACT

An ink jet composition set includes: a treatment liquid composition; and a first ink composition, in which the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

The present application is based on, and claims priority from JP Application Serial Number 2024-231560, filed Dec. 27, 2024, the disclosure of which is hereby incorporated by reference herein in its entirety.

### BACKGROUND

### 1. Technical Field

The present disclosure relates to an ink jet composition ink set, an ink jet recording method, and an ink jet recording apparatus.

### 2. Related Art

An ink jet recording method enables recording of high-definition images with a relatively simple apparatus and is developing rapidly in various fields. Among these, various studies are also conducted on ink jet recording methods used for fabrics. For example, in JP-A-2019-157071, an object thereof is to provide a clear ink composition for ink jet printing, an ink set for ink jet printing, and an ink jet printing method that can improve rubbing fastness without impairing the hand of fabrics, and this describes a clear ink composition for ink jet printing that contains resin particles, a lubricant, and water; a resin in the resin particles is a urethane resin having a crosslinkable group; and a dried coating film of the clear ink composition has a Young's modulus of 5 to 70 MPa.

Beginning with the ink jet composition described in JP-A-2019-157071, studies are conducted to improve the rubbing fastness of recorded matters.

### SUMMARY

According to an aspect of the present disclosure, there is provided an ink jet composition set including: a treatment liquid composition; and a first ink composition, in which the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

According to another aspect of the present disclosure, there is provided an ink jet recording method including: a treatment liquid depositing step of ejecting a treatment liquid composition by an ink jet method to deposit the treatment liquid composition on a fabric; and a first ink depositing step of ejecting a first ink composition by an ink jet method to deposit the first ink composition on the fabric, in which the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

According to still another aspect of the present disclosure, there is provided an ink jet recording apparatus including: an ink jet head that ejects a liquid by an ink jet method to deposit the liquid on a fabric; and a control section that controls ejection of the liquid, in which the control section executes a treatment liquid depositing step of ejecting a treatment liquid composition by an ink jet method to deposit the treatment liquid composition on a fabric, and a first ink depositing step of ejecting a first ink composition by an ink jet method to deposit the first ink composition on the fabric, the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

### BRIEF DESCRIPTION OF THE DRAWINGS

FIG. 1 shows an example of a recording apparatus used in the present embodiment.

FIG. 2 is Table 1 showing compositions of treatment liquids used in examples.

FIG. 3 is Table 2 showing compositions of ink compositions used in the examples.

FIG. 4 is Table 3 showing compositions of ink compositions used in the examples.

FIG. 5 is Table 4 showing compositions of an ink jet composition set used in the examples and evaluation results.

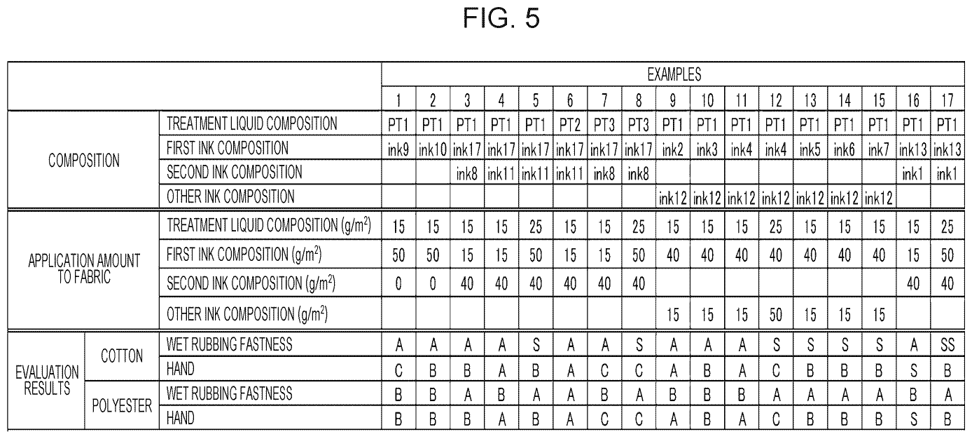

FIG. 6 is Table 5 showing compositions of the ink jet composition set used in the examples and evaluation results.

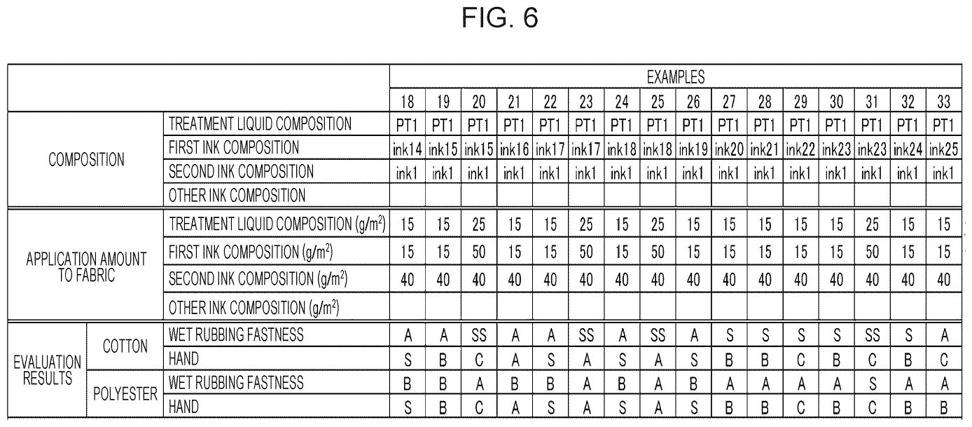

FIG. 7 is Table 6 showing compositions of the ink jet composition set used in the examples and evaluation results.

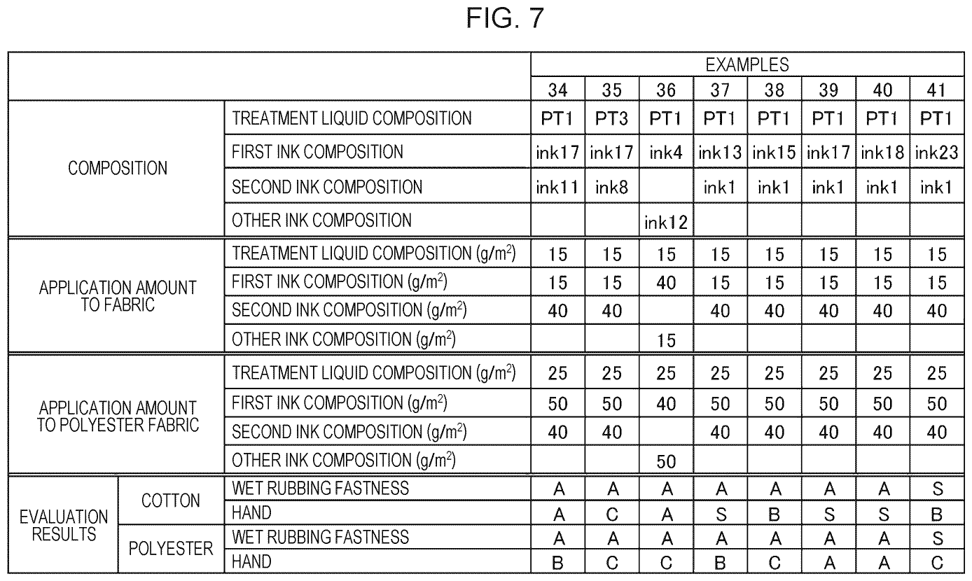

FIG. 8 is Table 7 showing compositions of the ink jet composition set used in the examples and evaluation results.

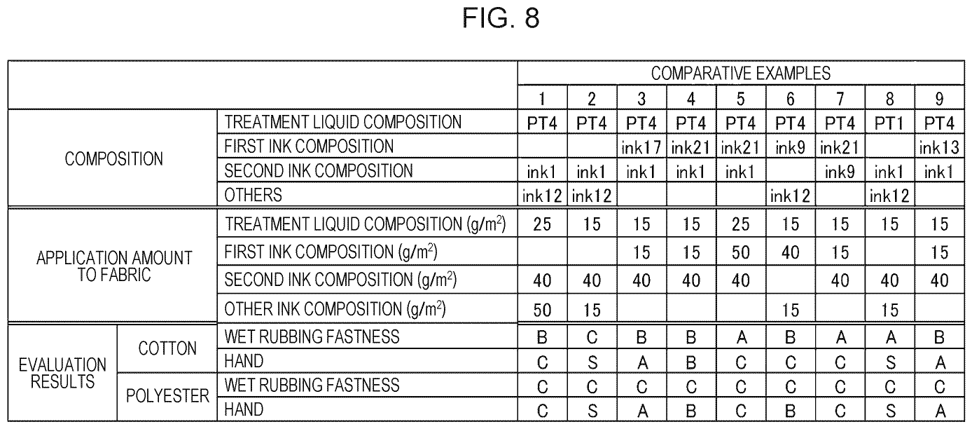

### DESCRIPTION OF EMBODIMENTS

Hereinafter, the embodiment of the present disclosure (hereinafter, “the present embodiment”) is described in detail with reference to the drawings as necessary; however, the present disclosure is not limited to this, and various modifications can be made without departing from the gist of the present disclosure.

### 1. Ink Jet Composition Set

An ink jet composition set of the present embodiment includes a treatment liquid composition and a first ink composition, in which the treatment liquid composition contains an acid serving as a flocculating agent that flocculates components in the first ink composition, and water, and the first ink composition contains a crosslinking agent having a crosslinkable group (hereinafter, also simply referred to as a “crosslinking agent”) and/or resin particles having a crosslinkable group (hereinafter, also referred to as “crosslinkable resin particles”), a base, and water.

By containing a crosslinking agent or crosslinkable resin particles in the ink composition, wet rubbing fastness of recorded matters can be improved. However, when a treatment liquid composition containing a multivalent metal salt as a flocculating agent in the related art is used in combination with an ink composition containing a crosslinking agent or crosslinkable resin particles, multivalent metal ions and functional groups such as carboxyl groups undergo multivalent interactions to form bonds. Because of steric hindrance of these bonds, the crosslinking reaction of the crosslinking agent or the crosslinkable resin particles is inhibited, and the effect of improving wet rubbing fastness decreases. Although use of a monovalent metal salt as the flocculating agent is conceivable, monovalent metal salts have low flocculation power, and color developability of the resulting recorded matter decreases. Therefore, improving wet rubbing fastness by using metal salts is difficult. In addition, when the ink composition contains a crosslinking agent or crosslinkable resin particles, presumably because of the action in which the above-described bonds are formed with flocculating agents in the related art such as multivalent metal salts, the coating film of the ink composition becomes harder and the hand of the recorded matter deteriorates in some cases.

Meanwhile, in the present embodiment, a treatment liquid composition containing an acid serving as a flocculating agent is used. Since the acid can flocculate the ink composition without undergoing multivalent interactions with functional groups in the crosslinking agent or the crosslinkable resin particles and without inhibiting the crosslinking reaction, wet rubbing fastness and hand can be improved.

Hereinafter, each component contained in the ink jet composition set in the present embodiment will be described in detail.

### 1.1. First Ink Composition

The first ink composition in the present embodiment contains a crosslinking agent having a crosslinkable group and/or resin particles having a crosslinkable group, a base, and water. By the first ink composition containing a crosslinking agent having a crosslinkable group or resin particles having a crosslinkable group, a crosslinking reaction proceeds on a recording medium, and the wet rubbing fastness of the resulting coating film is improved.

### 1.1.1. Resin Particles

In the present embodiment, the resin particles are particles containing a resin, and either resin particles in an emulsion state or resin particles in a powder form can be used. From the viewpoint of suppressing an increase in the viscosity of the first ink composition, it is preferable to use resin particles in an emulsion state.

The resin particles are not particularly limited, and examples thereof include a urethane resin, an acrylic resin (including a styrene-acrylic resin), a fluorene-based resin, a polyolefin resin, a rosin-modified resin, a terpene resin, a polyester resin, a polyamide resin, an epoxy resin, a vinyl chloride resin, a vinyl chloride-vinyl acetate copolymer, an ethylene-vinyl acetate resin.

### 1.1.1.1. Resin Particles Having Crosslinkable Group

In the present embodiment, it is preferable that the first ink composition contains resin particles having a crosslinkable group. In the present embodiment, the “crosslinkable group” is a group capable of forming a crosslinked structure through a reaction. Examples thereof include a crosslinkable group that reacts between crosslinkable groups to form a crosslinked structure, or a crosslinkable group that reacts with a functional group different from the crosslinkable group to form a crosslinked structure. The crosslinkable group is not particularly limited, and examples thereof include an oxazoline group, a carbodiimide group, an isocyanate group, a blocked isocyanate group, a silanol group, an amide group, and a hydrazide group. Among these, the crosslinkable group is preferably an oxazoline group, a carbodiimide group, and a blocked isocyanate group. By using these resin particles having the crosslinkable group, wet rubbing fastness and the hand of the recorded matter tend to be further improved. These resin particles having the crosslinkable group are used singly or in combination of two or more kinds.

A method for obtaining resin particles having a crosslinkable group is not particularly limited, and the resin particles having a crosslinkable group may be obtained by polymerizing a monomer having a crosslinkable group, may be obtained by a polymerization reaction accompanied by generation reaction of a crosslinkable group, or may be obtained by causing a crosslinking agent to react with resin particles. In addition, as the resin particles having a crosslinkable group, a commercially available product may be used.

A blocked isocyanate group is a functional group in which an isocyanate group is chemically protected with a blocking agent or the like. Examples of commercially available resin particles having a blocked isocyanate group include TAKELAC WS-5984 (trade name, manufactured by Mitsui Chemicals, Inc.) and ETERNACOLL UW-1501F (trade name, manufactured by UBE Corporation).

The silanol group is not particularly limited, and examples thereof include a triethoxysilyl group, a trimethoxysilyl group, and a tris(2-methoxyethoxy)silyl group. Examples of commercially available resin particles having a silanol group include TAKELAC WS-4022 (trade name, manufactured by Mitsui Chemicals, Inc.).

The content of the resin particles having a crosslinkable group in the first ink composition is preferably 1% to 15% by mass with respect to the total amount of the first ink composition, more preferably 3% to 12% by mass, still more preferably 3% to 11% by mass, particularly preferably 5% to 10% by mass, and most preferably 6% to 10% by mass. By setting the content of the resin particles having a crosslinkable group within the above-described range, wet rubbing fastness and the hand of the recorded matter tend to be further improved.

### 1.1.1.2. Resin Particles Having No Crosslinkable Group

The first ink composition in the present embodiment may contain resin particles having no crosslinkable group. Examples of the resin particles having no crosslinkable group include a polyolefin resin such as polyethylene and polypropylene; a polyvinyl chloride resin; a non-crosslinkable polyurethane resin; a polyester resin; and a silicone resin. Examples of a commercially available non-crosslinkable polyurethane resin include HYDRAN WLS-213 (non-crosslinkable polyurethane resin, trade name, manufactured by DIC Corporation). These resin particles having no crosslinkable group are used singly or in combination of two or more kinds.

The content of the resin particles having no crosslinkable group in the first ink composition is preferably 1% to 15% by mass with respect to the total amount of the first ink composition, more preferably 3% to 12% by mass, still more preferably 3% to 11% by mass, particularly preferably 5% to 10% by mass, and most preferably 6% to 9.5% by mass. By setting the content of the resin particles having no crosslinkable group within the above-described range, wet rubbing fastness and the hand of the recorded matter tend to be further improved.

### 1.1.2. Crosslinking Agent Having Crosslinkable Group

In the present embodiment, it is also preferable that the first ink composition contains a crosslinking agent having a crosslinkable group. The crosslinking agent having a crosslinkable group in the present embodiment is not particularly limited, and examples thereof include an isocyanate crosslinking agent, a blocked isocyanate crosslinking agent, an oxazoline crosslinking agent, an aziridine crosslinking agent, a dihydrazide crosslinking agent, and a carbodiimide crosslinking agent. Among these, the crosslinking agent contains preferably one or more selected from the group consisting of an oxazoline crosslinking agent, a carbodiimide crosslinking agent, and a blocked isocyanate crosslinking agent. By using these crosslinking agents, wet rubbing fastness and the hand of the recorded matter tend to be further improved. These crosslinking agents are used singly or in combination of two or more kinds.

A blocked isocyanate crosslinking agent is a compound in which an isocyanate group is chemically protected with a blocking agent or the like. As the blocked isocyanate crosslinking agent, an isocyanate crosslinking agent, such as an aliphatic polyisocyanate, an alicyclic polyisocyanate, an araliphatic polyisocyanate, or an aromatic polyisocyanate, that is reacted with a blocking agent is used. As the blocked isocyanate crosslinking agent, a commercially available product may be used, and examples thereof include MEIKANATE TP-10 (trade name, manufactured by Meisei Chemical Works, LTD.).

The oxazoline crosslinking agent is not particularly limited, and examples thereof include a polymer obtained by homopolymerizing an oxazoline-group-containing ethylenically unsaturated monomer such as 2-isopropenyl-2-oxazoline or 2-vinyl-2-oxazoline, and a polymer obtained by copolymerizing the above-described unsaturated monomer with another unsaturated monomer. As the oxazoline crosslinking agent, a commercially available product may be used, and examples thereof include EPOCROS WS-700, EPOCROS K-2010E, EPOCROS K-2020E, and EPOCROS K-2035E (trade names, manufactured by NIPPON SHOKUBAI CO., LTD.).

The carbodiimide crosslinking agent is not particularly limited, and examples thereof include a compound containing two or more carbodiimide groups in one molecule. As the carbodiimide crosslinking agent, a commercially available product may be used, and examples thereof include CARBODILITE E-02 and CARBODILITE E-05 (trade names, manufactured by Nisshinbo Chemical Inc.).

The content of the crosslinking agent is preferably 0.1% to 15% by mass with respect to the total amount of the first ink composition, more preferably 0.3% to 10% by mass, still more preferably 0.5% to 5% by mass, particularly preferably 1% to 4% by mass, and most preferably 1.5% to 3.5% by mass. By setting the content of the crosslinking agent within the above-described range, wet rubbing fastness and the hand of the recorded matter tend to be further improved.

### 1.1.3. Colorant

The first ink composition in the present embodiment contains a colorant and may be colored, with the content of the colorant being greater than 0.1% by mass with respect to the total amount of the first ink composition. Since the first ink composition is a colored ink containing a colorant, it is not necessary to further use another ink composition, and the ink jet composition set can be used as an ink jet composition set requiring a simpler process and a smaller applied amount.

The colorant in the present embodiment is not particularly limited; examples thereof include a pigment and a dye, and the colorant is preferably a pigment. By the first ink composition containing a pigment, the effects of the present embodiment become more pronounced. These colorants are used singly or in combination of two or more kinds.

### 1.1.3.1. Pigment

The pigment is not particularly limited, and examples thereof include an organic pigment and an inorganic pigment. Examples of the organic pigment include an azo pigment, a polycyclic pigment, a nitro pigment, a nitroso pigment, and aniline black. Examples of the inorganic pigment include titanium oxide, iron oxide, and carbon black. Examples of the carbon black include carbon black produced by known methods such as a contact method, a furnace method, and a thermal method.

Examples of the carbon black include Colour Index Generic Name (C.I.) Pigment Black 1, 7, and 11. As carbon blacks, a commercially available product may be used, and examples thereof include: No. 2300, No. 900, MCF88, No. 33, No. 40, No. 45, No. 52, MA7, MA8, MA100, and No. 2200B (trade names, manufactured by Mitsubishi Chemical Group Corporation); Raven 5750, 5250, 5000, 3500, 1255, and 700 (trade names, manufactured by Birla Carbon Company (formerly Columbian Chemicals Company)); Regal 400R, 330R, and 660R, Mogul L, Monarch 700, 800, 880, 900, 1000, 1100, 1300, and 1400 (trade names, manufactured by Cabot Corporation); and Color Black FW1, FW2, FW2V, FW18, FW200, S150, S160, S170, Printex 35, U, V, and 140U, and Special Black 6, 5, 4A, and 4 (trade names, manufactured by Orion Engineered Carbons (formerly Degussa)).

The pigment may be a self-dispersing pigment that disperses by itself without use of a dispersant, or a resin-dispersed pigment dispersed with a dispersant, and is preferably a self-dispersing pigment. Since the first ink composition contains a self-dispersing pigment, the reaction with the treatment liquid composition more readily proceeds, and wet rubbing fastness is readily improved further. The self-dispersing pigment can be prepared, for example, by methods described in the examples to be described below.

The content of the colorant is preferably greater than 0.1% by mass with respect to the total amount of the first ink composition, more preferably 1% to 10% by mass, still more preferably 2% to 9% by mass, particularly preferably 2% to 7% by mass, more particularly 3% to 6% by mass, and most preferably 4.5% to 8% by mass. By setting the content of the colorant within the above-described range, wet rubbing fastness and the hand of the recorded matter tend to be further improved.

When the first ink composition contains a colorant and is colored, with the content of the colorant being greater than 0.1% by mass with respect to the total amount of the first ink composition, the total content of resin components in the first ink composition is preferably 3% to 8% by mass with respect to the total amount of the first ink composition. The total content of resin components in the first ink composition is more preferably 3.5% to 7% by mass, still more preferably 3.5% to 6% by mass, and particularly preferably 4% to 6% by mass. By setting the total content of resin components within the above-described range, wet rubbing fastness and the hand of the recorded matter tend to be further improved. The total content of resin components refers to the sum of the contents of resin particles having a crosslinkable group, resin particles having no crosslinkable group, and resin components other than resin particles.

In another embodiment, the first ink composition may be a clear ink, with the content of the colorant being 0.1% by mass or less with respect to the total amount of the first ink composition. Appropriate deposited amounts of the crosslinking agent and the crosslinkable resin particles vary depending on the type of fabric. By using a clear ink in which the content of the colorant is at or below a predetermined level, it is possible to change the deposited amounts of the crosslinking agent and the crosslinkable resin particles according to the type of fabric without changing the hue. As a result, regardless of the type of fabric, wet rubbing fastness and the hand of the recorded matter tend to be further improved.

When the first ink composition is a clear ink, it is preferable to also use a second ink composition to be described below.

With such a configuration, the amount of the crosslinking agent or the crosslinkable resin particles in the ink coating film can be adjusted by the deposited amount of the first ink composition, which is a clear ink, and the amount of the colorant in the ink coating film can be adjusted by the second ink composition. Therefore, for example, when cotton, on which wet rubbing fastness is readily improved, is used as a recording medium, the deposited amount of the crosslinking agent or the crosslinkable resin particles can be reduced to further improve the hand, and when polyester, on which wet rubbing fastness is difficult to improve, is used, the deposited amount of the crosslinking agent or the crosslinkable resin particles can be increased to further improve wet rubbing fastness. In this way, by using the first ink composition and the second ink composition, the amount of the crosslinking agent or the crosslinkable resin particles and the amount of the colorant in the ink coating film can be independently adjusted, thereby enabling adjustment of wet rubbing fastness and hand according to the type of recording medium.

When the first ink composition is a clear ink, with the content of the colorant being 0.1% by mass or less with respect to the total amount of the first ink composition, the total content of resin components in the first ink composition is preferably 5% to 15% by mass with respect to the total amount of the first ink composition. The total content of resin components in the first ink composition is more preferably 8% to 13% by mass, still more preferably 8.5% to 12% by mass, and particularly preferably 8.5% to 11% by mass. By setting the total content of resin components within the above-described range, wet rubbing fastness and the hand of the recorded matter tend to be further improved.

### 1.1.4. Organic Solvent

The first ink composition may contain an organic solvent. The organic solvent is not particularly limited, and examples thereof include monoalcohols, polyhydric alcohols, glycol ethers, nitrogen-containing solvents, ethers, and esters. These organic solvents are used singly or in combination of two or more kinds.

Examples of the polyhydric alcohols include diol compounds and triol compounds. Specific examples include ethylene glycol, propylene glycol, 1,2-propanediol, 1,2-butanediol, 1,3-propanediol, 1,4-butanediol, diethylene glycol, triethylene glycol, dipropylene glycol, trimethylolpropane, 1,2-pentanediol, 1,2-hexanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and glycerin.

Specific examples of the glycol ether compounds include triethylene glycol monobutyl ether, ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether.

The content of the organic solvent in the first ink composition is preferably 1% to 25% by mass with respect to the total amount of the first ink composition, more preferably 10% to 20% by mass, and still more preferably 12% to 15% by mass. By setting the content of the organic solvent within the above-described range, wet rubbing fastness and the hand of the recorded matter tend to be further improved.

### 1.1.5. Surfactant

An aqueous pigment ink composition may contain a surfactant. Examples of the surfactant include an acetylene glycol surfactant, a fluorinated surfactant, and a silicone surfactant. These surfactants are used singly or in combination of two or more kinds.

The acetylene glycol surfactant is not particularly limited, and examples thereof include 2,4,7,9-tetramethyl-5-decyne-4,7-diol and alkylene oxide adducts of 2,4,7,9-tetramethyl-5-decyne-4,7-diol, and 2,4-dimethyl-5-decyne-4-ol and alkylene oxide adducts of 2,4-dimethyl-5-decyne-4-ol. Examples of a commercially available acetylene glycol surfactant include SURFYNOL 465 (trade name, manufactured by Nissin Chemical CO., LTD.).

The fluorinated surfactant is not particularly limited, and examples thereof include perfluoroalkyl sulfonates, perfluoroalkyl carboxylates, perfluoroalkyl phosphate esters, perfluoroalkyl ethylene oxide adducts, perfluoroalkyl betaines, and perfluoroalkyl amine-oxide compounds.

The silicone surfactant is not particularly limited, and examples thereof include polysiloxane compounds and polyether-modified organosiloxanes.

The content of the surfactant in the first ink composition is preferably 0.01% to 5% by mass with respect to the total amount of the first ink composition, more preferably 0.1% to 3% by mass, and still more preferably 0.3% to 1% by mass. By setting the content of the surfactant within the above-described range, wet rubbing fastness and the hand of the recorded matter tend to be further improved.

### 1.1.6. Base

The first ink composition contains a base. This can suppress reactions of the crosslinking agent and the crosslinkable resin particles, thereby further improving storage stability of the ink and ejection reliability. When such an ink composition comes into contact with the treatment liquid composition on the recording medium, the acid in the treatment liquid composition causes the crosslinking reaction of the crosslinking agent and the crosslinkable resin particles to proceed.

The base is not particularly limited, and examples thereof include an organic base and an inorganic base. Examples of the organic base include triethanolamine, diethanolamine, monoethanolamine, tripropanolamine, triisopropanolamine, diisopropanolamine, and tris(hydroxymethyl)aminomethane. Examples of the inorganic base include metal hydroxides such as lithium hydroxide, sodium hydroxide, and potassium hydroxide; potassium dihydrogen phosphate, disodium hydrogen phosphate, potassium carbonate, sodium carbonate, sodium hydrogen carbonate, and ammonia. These bases are used singly or in combination of two or more kinds.

The content of the base in the first ink composition is preferably 0.01% to 5% by mass with respect to the total amount of the first ink composition, more preferably 0.1% to 3% by mass, and still more preferably 0.5% to 2% by mass. By setting the content of the base within the above-described range, wet rubbing fastness and the hand of the recorded matter tend to be further improved.

### 1.1.7. Water

The first ink composition in the present embodiment contains water. As the water, it is preferable to use water from which ionic impurities are removed as much as possible, and examples thereof include pure water such as ion-exchanged water, reverse-osmosis water, and distilled water, as well as ultrapure water.

The content of the water is preferably 40% to 99% by mass with respect to the total amount of the first ink composition, more preferably 50% to 95% by mass, still more preferably 60% to 90% by mass, particularly preferably 65% to 85% by mass, and most preferably 70% to 80% by mass. By setting the content of the water within the above-described range, wet rubbing fastness and the hand of the recorded matter tend to be further improved.

### 1.1.8. Other Components

As components other than those described above, for example, various additives may be contained as necessary, such as a chelating agent, a softener, a solubilizer, a viscosity modifier, an ultraviolet absorber, an antioxidant, and a corrosion inhibitor.

### 1.2. Treatment Liquid Composition

The treatment liquid composition in the present embodiment is used by being deposited on a recording medium, and contains an acid serving as a flocculating agent that flocculates components in the first ink composition, and water. In an ink jet composition set, the treatment liquid composition may be one kind or two or more kinds.

The pH of the treatment liquid composition is preferably 1.5 to 7.0, more preferably 2.0 to 6.5, still more preferably 3 to 6, and particularly preferably 3.5 to 5. By setting the pH within the above-described range, wet rubbing fastness and the hand of the recorded matter tend to be further improved.

### 1.2.1. Acid

The treatment liquid composition in the present embodiment contains an acid. The acid serving as a flocculating agent has a flocculating action on the ink composition, and, because the acid does not bind to functional groups of the crosslinking agent or the crosslinkable resin particles contained in the ink composition, the resulting ink coating film does not become excessively hard and exhibits good hand. Further, since the acid does not inhibit the crosslinking reaction of the crosslinking agent or the crosslinkable resin particles, wet rubbing fastness is further improved. The acid is, for example, an organic acid or an inorganic acid, and the acid is preferably an organic acid. These acids are used singly or in combination of two or more kinds.

The organic acid is not particularly limited, and examples thereof include lactic acid, malonic acid, citric acid, adipic acid, succinic acid, malic acid, levulinic acid, glutaric acid, polyacrylic acid, acetic acid, glycolic acid, maleic acid, ascorbic acid, fumaric acid, tartaric acid, sulfonic acid, orthophosphoric acid, pyrrolidonecarboxylic acid, pyronecarboxylic acid, pyrrolecarboxylic acid, furancarboxylic acid, pyridinecarboxylic acid, coumaric acid, thiophenecarboxylic acid, and nicotinic acid. The inorganic acid is not particularly limited, and examples thereof include sulfuric acid, hydrochloric acid, nitric acid, and phosphoric acid, as well as acidic salts such as disodium hydrogen phosphate.

The content of the acid in the treatment liquid composition is preferably 1% to 30% by mass with respect to the total amount of the treatment liquid composition, more preferably 3% to 20% by mass, still more preferably 4% to 15% by mass, particularly preferably 5% to 15% by mass, more particularly 5% to 12% by mass, and most preferably 8% to 12% by mass. By setting the content of the acid within the above-described range, wet rubbing fastness and the hand of the recorded matter tend to be further improved.

It is also preferable that the treatment liquid composition does not contain a multivalent metal salt. When the treatment liquid composition contains a multivalent metal salt, the multivalent metal salt and the crosslinking agent or the crosslinkable resin particles contained in the ink composition form bonds through multivalent interactions, thereby causing steric hindrance. Consequently, the crosslinking reaction of the crosslinking agent or the crosslinkable resin particles is inhibited, and the effect of improving wet rubbing fastness may decrease. Accordingly, by not containing a multivalent metal salt, wet rubbing fastness tends to be further improved. In addition, when bonds due to multivalent interactions are formed between the multivalent metal salt and the crosslinking agent or the crosslinkable resin particles, the ink coating film formed on the recording medium becomes excessively hard, and the hand of the recorded matter tends to deteriorate. Therefore, by not containing a multivalent metal salt, the hand of the recorded matter tends to be further improved.

From such a viewpoint, the content of the multivalent metal salt is preferably 2% by mass or less with respect to the total amount of the treatment liquid composition, more preferably 1% by mass or less, still more preferably 0.5% by mass or less, particularly preferably 0.1% by mass or less, and most preferably 0% by mass. By setting the content of the multivalent metal salt within the above-described range, wet rubbing fastness and the hand of the recorded matter tend to be further improved.

### 1.2.2. Base

The treatment liquid composition may contain a base. Examples of the base include those exemplified as the base for the first ink composition.

The content of the base in the treatment liquid composition is preferably 0.1% to 10% by mass with respect to the total amount of the treatment liquid composition, more preferably 0.2% to 5% by mass, and still more preferably 0.5% to 3% by mass. By setting the content of the base within the above-described range, wet rubbing fastness and the hand of the recorded matter tend to be further improved.

### 1.2.3. Organic Solvent

In the present embodiment, the treatment liquid composition may contain an organic solvent. Examples of the organic solvent for the treatment liquid composition include those exemplified as the organic solvent for the first ink composition.

The content of the organic solvent in the treatment liquid composition is preferably 1% to 50% by mass with respect to the total amount of the treatment liquid composition, more preferably 10% to 40% by mass, still more preferably 20% to 35% by mass, and still more preferably 19% to 27% by mass. By setting the content of the organic solvent within the above-described range, wet rubbing fastness and the hand of the recorded matter tend to be further improved.

### 1.2.4. Surfactant

In the present embodiment, the treatment liquid composition may contain a surfactant. Examples of the surfactant for the treatment liquid composition include those exemplified as the surfactant for the first ink composition.

The content of the surfactant in the treatment liquid composition is preferably 0.01% to 5% by mass with respect to the total amount of the treatment liquid composition, more preferably 0.1% to 3% by mass, and still more preferably 0.3% to 1% by mass. By setting the content of the surfactant within the above-described range, wet rubbing fastness and the hand of the recorded matter tend to be further improved.

### 1.2.5. Water

In the present embodiment, the treatment liquid composition contains water. Examples of the water for the treatment liquid composition include those exemplified as the water for the first ink composition.

The content of the water in the treatment liquid composition is preferably 50% to 99% by mass with respect to the total amount of the treatment liquid composition, more preferably 55% to 90% by mass, and still more preferably 60% to 75% by mass. By setting the content of the water within the above-described range, wet rubbing fastness and the hand of the recorded matter tend to be further improved.

### 1.2.6. Other Components

As components other than those described above, for example, various additives may be contained as necessary, such as resin particles, a pH adjuster, a chelating agent, a softener, a solubilizer, a viscosity modifier, an ultraviolet absorber, an antioxidant, and a corrosion inhibitor.

### 1.3. Second Ink Composition

The ink jet composition set of the present embodiment may include a second ink composition. The second ink composition may contain a colorant, resin particles, a base, and water. Consequently, the amount of the crosslinking agent or the crosslinkable resin particles in the ink coating film can be adjusted by the deposited amount of the first ink composition, and the amount of the colorant in the ink coating film can be adjusted by the second ink composition. Accordingly, for example, when cotton, on which wet rubbing fastness is readily improved, is used as a recording medium, the deposited amount of the crosslinking agent or the crosslinkable resin particles can be reduced to further improve the hand, and when polyester, on which wet rubbing fastness is difficult to improve, is used, the deposited amount of the crosslinking agent or the crosslinkable resin particles can be increased to further improve wet rubbing fastness. In this way, by using the first ink composition and the second ink composition, the amount of the crosslinking agent or the crosslinkable resin particles and the amount of the colorant in the ink coating film can be independently adjusted, thereby enabling adjustment of wet rubbing fastness and hand according to the type of recording medium.

When the ink jet composition set of the present embodiment includes the second ink composition, it is preferable that the first ink composition is the above-described clear ink. As a result, the above-described effects can be more readily obtained.

### 1.3.1. Resin Particles

The second ink composition in the present embodiment contains resin particles. Examples of the resin particles in the second ink composition include those exemplified, for the first ink composition, as the resin particles having a crosslinkable group and as the resin particles having no crosslinkable group.

### 1.3.1.1. Resin Particles Having Crosslinkable Group

In the present embodiment, the second ink composition may contain resin particles having a crosslinkable group. Examples of the resin particles having a crosslinkable group in the second ink composition include those exemplified, for the first ink composition, as the resin particles having a crosslinkable group.

The content of the resin particles having a crosslinkable group in the second ink composition is preferably 1% to 15% by mass with respect to the total amount of the second ink composition, more preferably 2% to 10% by mass, still more preferably 3% to 9% by mass, particularly preferably 3% to 8% by mass, more particularly 4% to 7% by mass, and most preferably 4% to 6% by mass. By setting the content of the resin particles having a crosslinkable group within the above-described range, wet rubbing fastness and the hand of the recorded matter tend to be further improved.

### 1.3.1.2. Resin Particles Having No Crosslinkable Group

In the present embodiment, the second ink composition may contain resin particles having no crosslinkable group. Examples of the resin particles having no crosslinkable group for the second ink composition include those exemplified, for the first ink composition, as the resin particles having no crosslinkable group.

The content of the resin particles having no crosslinkable group in the second ink composition is preferably 1% to 15% by mass with respect to the total amount of the second ink composition, more preferably 2% to 10% by mass, still more preferably 3% to 9% by mass, particularly preferably 3% to 8% by mass, more particularly 4% to 7% by mass, and most preferably 4% to 6% by mass. By setting the content of the resin particles having no crosslinkable group within the above-described range, wet rubbing fastness and the hand of the recorded matter tend to be further improved.

The total content of resin components in the second ink composition is preferably 1% to 15% by mass with respect to the total amount of the second ink composition, more preferably 2% to 10% by mass, still more preferably 3% to 8% by mass, and particularly preferably 4% to 6% by mass. By setting the total content of the resin components within the above-described range, wet rubbing fastness and the hand of the recorded matter tend to be further improved.

### 1.3.2. Crosslinking Agent Having Crosslinkable Group

In the present embodiment, the second ink composition may contain a crosslinking agent having a crosslinkable group. Examples of the crosslinking agent for the second ink composition include those exemplified as the crosslinking agent for the first ink composition.

The content of the crosslinking agent in the second ink composition is preferably 0.1% to 10% by mass with respect to the total amount of the second ink composition, more preferably 0.5% to 5% by mass, and still more preferably 1% to 3% by mass. By setting the content of the crosslinking agent within the above-described range, wet rubbing fastness and the hand of the recorded matter tend to be further improved.

### 1.3.3. Colorant

In the present embodiment, the second ink composition contains a colorant. Examples of the colorant for the second ink composition include those exemplified as the colorant for the first ink composition.

The content of the colorant is preferably 0.1% to 15% by mass with respect to the total amount of the second ink composition, more preferably 1% to 10% by mass, and still more preferably 3% to 7% by mass. By setting the content of the colorant within the above-described range, wet rubbing fastness and the hand of the recorded matter tend to be further improved.

### 1.3.4. Base

In the present embodiment, the second ink composition contains a base. Examples of the base for the second ink composition include those exemplified as the base for the first ink composition.

The content of the base in the second ink composition is preferably 0.1% to 5% by mass with respect to the total amount of the second ink composition, more preferably 0.3% to 4% by mass, and still more preferably 0.5% to 3% by mass. By setting the content of the base within the above-described range, wet rubbing fastness and the hand of the recorded matter tend to be further improved.

### 1.3.5. Organic Solvent

In the present embodiment, the second ink composition may contain an organic solvent. Examples of the organic solvent for the second ink composition include those exemplified as the organic solvent for the first ink composition.

The content of the organic solvent in the second ink composition is preferably 1% to 25% by mass with respect to the total amount of the second ink composition, more preferably 10% to 20% by mass, and still more preferably 12% to 15% by mass. By setting the content of the organic solvent within the above-described range, wet rubbing fastness and the hand of the recorded matter tend to be further improved.

### 1.3.6. Surfactant

In the present embodiment, the second ink composition may contain a surfactant. Examples of the surfactant for the second ink composition include those exemplified as the surfactant for the first ink composition.

The content of the surfactant in the second ink composition is preferably 0.01% to 5% by mass with respect to the total amount of the second ink composition, more preferably 0.1% to 3% by mass, and still more preferably 0.3% to 1% by mass. By setting the content of the surfactant within the above-described range, wet rubbing fastness and the hand of the recorded matter tend to be further improved.

### 1.3.7. Water

In the present embodiment, the second ink composition contains water. Examples of the water for the second ink composition include those exemplified as the water for the first ink composition.

The content of the water in the second ink composition is preferably 40% to 99% by mass with respect to the total amount of the second ink composition, more preferably 50% to 95% by mass, still more preferably 60% to 90% by mass, particularly preferably 65% to 85% by mass, and most preferably 70% to 80% by mass. By setting the content of water within the above-described range, wet rubbing fastness and the hand of the recorded matter tend to be further improved.

### 1.3.8. Other Components

As components other than those described above, for example, various additives may be contained as necessary, such as resin particles, a pH adjuster, a chelating agent, a softener, a solubilizer, a viscosity modifier, an ultraviolet absorber, an antioxidant, and a corrosion inhibitor.

### 2. Method for Preparing Treatment Liquid Composition and Ink Composition

As a method for preparing the treatment liquid composition and the ink composition, for example, each component can be mixed in any order and, as necessary, subjected to filtration or the like to remove impurities and foreign matter, thereby preparing the treatment liquid composition and the ink composition. As a method of mixing each component, a method of sequentially adding each component into a vessel equipped with a stirring device such as a mechanical stirrer or a magnetic stirrer, followed by stirring and mixing, is used. Examples of the filtration method include centrifugal filtration and filter filtration.

In the present embodiment, the ink jet composition set may contain other compositions and may contain, for example, another ink composition.

### 3. Recording Medium

As the recording medium of the present embodiment, for example, paper, film, cloth, metal, glass, and polymers can be used. Among these, a fabric is preferable, and the effects of the present embodiment become more pronounced when an image is recorded on a fabric.

A material constituting the fabric is not particularly limited, and examples thereof include natural fibers and synthetic fibers such as silk, cotton, wool, nylon, polyester, and rayon. The fabric may be made of a single kind of fiber or a blend of two or more kinds of fibers. As the fabric, a material formed from the fibers listed above in any form, such as a woven fabric, a knitted fabric, or a nonwoven fabric, may be used.

### 4. Recording Method

According to the present embodiment, there is provided an ink jet recording method including: a treatment liquid depositing step of ejecting a treatment liquid composition by an ink jet method to deposit the treatment liquid composition on a fabric; and a first ink depositing step of ejecting a first ink composition by an ink jet method to deposit the first ink composition on the fabric, in which the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

It is preferable that, in the first ink depositing step and the treatment liquid depositing step, the first ink composition and the treatment liquid composition are deposited on at least the same region on the fabric.

In addition, the order of the first ink depositing step and the treatment liquid depositing step is not particularly limited, and the first ink depositing step and the treatment liquid depositing step may be performed simultaneously, the treatment liquid depositing step may be performed first, or the first ink depositing step may be performed first.

When the first ink depositing step and the treatment liquid depositing step are performed simultaneously, it is preferable that the first ink depositing step and the treatment liquid depositing step are performed in the same scan by applying the first ink composition and the treatment liquid composition to the same region of the fabric.

Here, the term “scan” refers to moving the ink jet head relative to a recording region on the fabric. In this case, the ink jet head may be moved relative to the fabric for the scan, or the fabric may be moved relative to the ink jet head for the scan. Alternatively, both the ink jet head and the fabric may be moved so that their relative positional relationship changes.

The ink jet head can be mounted on, for example, a carriage. The ink jet head may be configured to move as the carriage moves; in this case as well, that is, it is the ink jet head that moves.

With the recording method of the present embodiment, recording can be performed using a treatment liquid composition containing an acid serving as a flocculating agent and a first ink composition containing a crosslinking agent having a crosslinkable group and/or resin particles having a crosslinkable group, thereby obtaining a recorded matter excellent in wet rubbing fastness and hand.

### 4.1. Treatment Liquid Depositing Step

The ink jet recording method according to the present embodiment includes a treatment liquid depositing step of ejecting a treatment liquid composition from a recording head to deposit the treatment liquid composition on a fabric, in which the treatment liquid composition contains an acid serving as a flocculating agent that flocculates components in the first ink composition, and water. As the treatment liquid composition of the present embodiment, those described above as the treatment liquid composition for the ink jet composition set of the present embodiment may be used.

The deposited amount of the treatment liquid composition in the treatment liquid depositing step is preferably 5 to 50 g/m², more preferably 10 to 40 g/m², and still more preferably 20 to 30 g/m². By setting the deposited amount of the treatment liquid composition within the above-described range, a recorded matter excellent in wet rubbing fastness and hand can be obtained.

### 4.2. First Ink Depositing Step

The ink jet recording method according to the present embodiment includes a first ink depositing step of ejecting a first ink composition by an ink jet method to deposit the first ink composition on a fabric, in which the first ink composition contains a crosslinking agent having a crosslinkable group and/or resin particles having a crosslinkable group, a base, and water. As the first ink composition of the present embodiment, those described above as the first ink composition for the ink jet composition set of the present embodiment may be used. The first ink depositing step may be performed simultaneously with the treatment liquid depositing step or before the treatment liquid depositing step.

The deposited amount I0 of the first ink composition in the first ink depositing step is preferably 15 to 70 g/m². The deposited amount I0 of the first ink composition in the first ink depositing step is more preferably 20 to 60 g/m², and still more preferably 30 to 50 g/m². By setting the deposited amount of the first ink composition within the above-described range, a recorded matter excellent in wet rubbing fastness and hand can be obtained.

### 4.3. Second Ink Depositing Step

The ink jet recording method according to the present embodiment may include a second ink depositing step of ejecting a second ink composition by an ink jet method to deposit the second ink composition on a fabric, in which the second ink composition may contain a colorant, resin particles, a base, and water. By including such a second ink depositing step, the deposited amount of the crosslinking agent or the crosslinkable resin particles can first be adjusted by the first ink composition, and then the deposited amount of the colorant can be further adjusted by the second ink composition. As the second ink composition of the present embodiment, those described above as the second ink composition for the ink jet composition set of the present embodiment may be used.

The order of the second ink depositing step and the first ink depositing step is not particularly limited, and the second ink depositing step and the first ink depositing step may be performed simultaneously, the second ink depositing step may be performed first, or the first ink depositing step may be performed first.

It is also preferable to perform the second ink depositing step before the first ink depositing step. When the first ink composition is the above-described clear ink, performing the second ink depositing step before the first ink depositing step can provide good rubbing fastness.

In addition, it is preferable that, in the first ink depositing step and the second ink depositing step, the first ink composition and the second ink composition are deposited on at least the same region on the fabric.

The deposited amount I1 of the second ink composition in the second ink depositing step is preferably 10 to 50 g/m^{2.} The deposited amount I1 of the second ink composition in the second ink depositing step is more preferably 20 to 45 g/m², and still more preferably 30 to 42 g/m². By setting the deposited amount of the second ink composition within the above-described range, a recorded matter excellent in wet rubbing fastness and hand can be obtained.

In the present embodiment, the deposited amount of the first ink composition may be varied according to the type of fabric to be used for recording. The degree to which the deposited amounts of the crosslinking agent having a crosslinkable group and the resin particles having a crosslinkable group contribute to wet rubbing fastness differs depending on the type of fabric. Accordingly, by varying the deposited amount of the first ink composition according to the type of fabric, wet rubbing fastness and hand tend to be more excellent. For example, when recording on cotton, which tends to exhibit relatively good wet rubbing fastness, reducing the amount of the first ink composition decreases the deposited amounts of the crosslinking agent having a crosslinkable group and the resin particles having a crosslinkable group, thereby tending to further improve the hand of the recorded matter. For example, when recording on polyester, which tends to exhibit relatively poor wet rubbing fastness, increasing the amount of the first ink composition increases the deposited amounts of the crosslinking agent having a crosslinkable group and the resin particles having a crosslinkable group, thereby tending to further improve wet rubbing fastness of the recorded matter.

### 5. Ink Jet Recording Apparatus

According to the present embodiment, there is provided an ink jet recording apparatus including: an ink jet head that ejects a liquid by an ink jet method to deposit the liquid on a fabric; and a control section that controls ejection of the liquid, in which the control section executes a treatment liquid depositing step of ejecting a treatment liquid composition by an ink jet method to deposit the treatment liquid composition on a fabric, and a first ink depositing step of ejecting a first ink composition by an ink jet method to deposit the first ink composition on the fabric, the treatment liquid composition contains an acid serving as a flocculating agent that flocculates components in the first ink composition, and water, and the first ink composition contains a crosslinking agent having a crosslinkable group and/or resin particles having a crosslinkable group, a base, and water.

With the recording apparatus of the present embodiment, recording can be performed using a treatment liquid composition containing an acid serving as a flocculating agent and a first ink composition containing a crosslinking agent having a crosslinkable group and/or resin particles having a crosslinkable group, thereby obtaining a recorded matter excellent in wet rubbing fastness and hand.

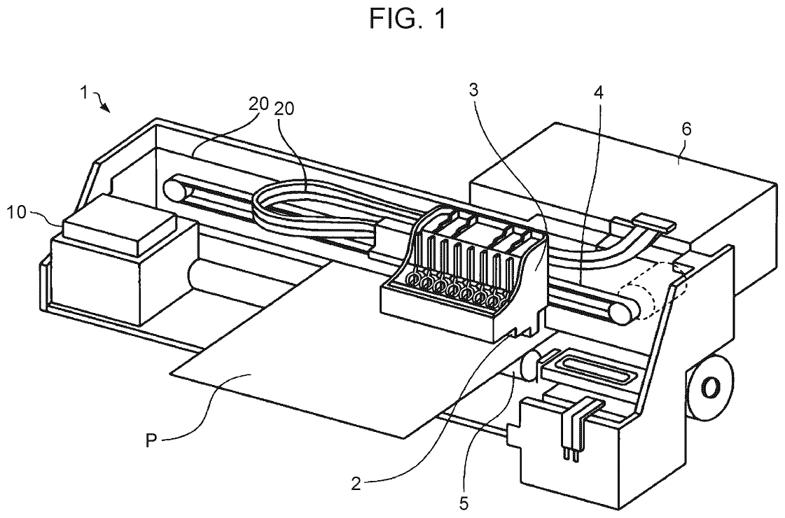

FIG. 1 is a perspective view showing a configuration of the recording apparatus in the present embodiment. A recording apparatus 1 shown in FIG. 1 is a serial printer; however, the recording apparatus in the present embodiment may also be a line printer. The serial printer refers to a printer in which a head unit is mounted on a carriage that moves in a main scanning direction (a lateral direction and a widthwise direction of the recording medium), and droplets are ejected from nozzles on the recording medium as the carriage moves. Additionally, the line printer refers to a printer in which the head is fixed, the recording medium is moved along a sub-scanning direction (a longitudinal direction and a transport direction of the recording medium), and droplets are ejected from head nozzles in conjunction with this movement.

As shown in FIG. 1, the recording apparatus 1 includes a carriage 3 on which an ink jet head 2 is mounted, a carriage moving mechanism 4 that moves the carriage 3 in a recording medium widthwise direction of a recording medium P, and a medium feeding mechanism 5 that transports the recording medium P in a recording medium feeding direction. In addition, the recording apparatus 1 also includes a control section 6 that controls the overall operation of the recording apparatus 1. The above-described recording medium widthwise direction is the main scanning direction (head scanning direction). The above-described medium feeding direction is the sub-scanning direction (a direction orthogonal to the main scanning direction).

As the recording apparatus 1 according to the present embodiment, a so-called off-carriage type printer in which an ink accommodating portion 10 is mounted on a housing or the like of the recording apparatus 1 and ink is supplied to the ink jet head 2 via an ink supply tube 20 is exemplified; however, the present disclosure is not limited to this. For example, a so-called on-carriage type printer in which an ink cartridge is mounted on the carriage may be used. Additionally, a line-head type printer in which a carriage is not provided may also be used.

The control section 6 controls a liquid ejection operation, a liquid feeding operation, and a maintenance operation. For example, the control section 6 outputs a drive signal to the ink jet head 2 to control ejection of ink onto the recording medium. The control section 6 may be configured using, for example, a processing circuit such as a central processing unit (CPU) or a field programmable gate array (FPGA), and a storage circuit such as a semiconductor memory. In particular, in the present embodiment, the control section executes a treatment liquid depositing step of ejecting a treatment liquid composition by an ink jet method to deposit the treatment liquid composition on a fabric, and a first ink depositing step of ejecting a first ink composition by an ink jet method to deposit the first ink composition on the fabric. The second ink depositing step of further depositing a second ink composition different from the first ink composition on the fabric may also be executed.

In the present embodiment, the control section may vary the deposited amount of the treatment liquid composition on the fabric according to the type of fabric. The degree to which the deposited amounts of the crosslinking agent and the crosslinkable resin particles contribute to wet rubbing fastness differs depending on the type of fabric. Accordingly, by varying the deposited amount of the treatment liquid composition according to the type of fabric, wet rubbing fastness and hand tend to be more excellent. For example, when recording on cotton, which tends to exhibit relatively good wet rubbing fastness, reducing the amount of the first ink composition decreases the deposited amounts of the crosslinking agent having a crosslinkable group and the resin particles having a crosslinkable group, thereby tending to further improve the hand of the recorded matter. For example, when recording on polyester, which tends to exhibit relatively poor wet rubbing fastness, increasing the amount of the first ink composition increases the deposited amounts of the crosslinking agent having a crosslinkable group and the resin particles having a crosslinkable group, thereby tending to further improve wet rubbing fastness of the recorded matter.

### EXAMPLES

Hereinafter, the present disclosure will be more specifically described with reference to Examples and Comparative Examples. The present disclosure is not limited in any way by the following Examples.

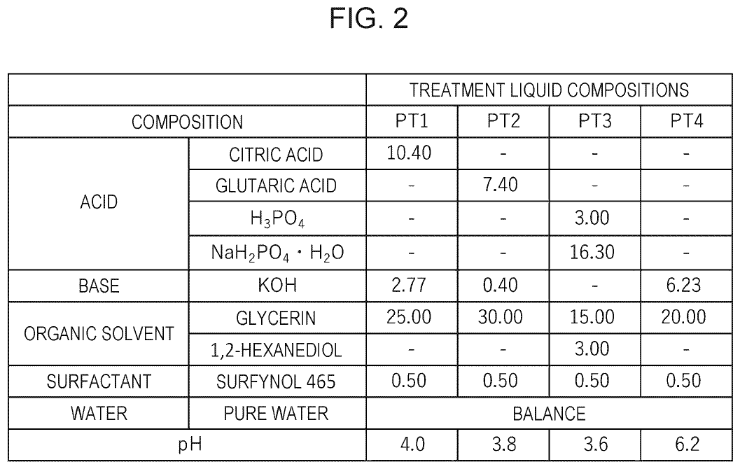

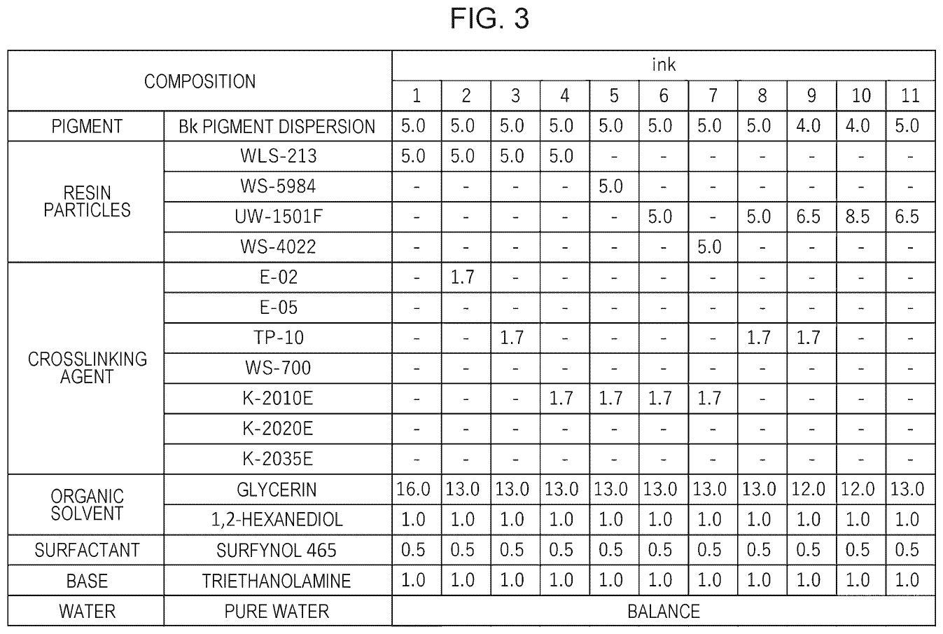

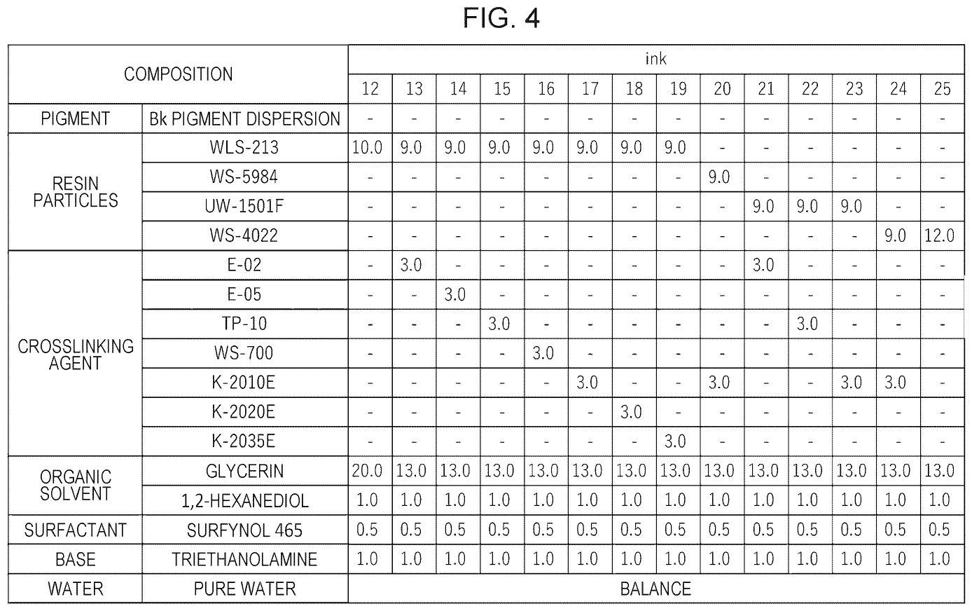

FIGS. 2 to 4 set forth Tables 1 to 3, which show the formulations of the compositions for the Examples and Comparative Examples.

### 1. Preparation of Each Composition

In order to obtain the compositions described in Tables 1 to 3, each component was charged into a mixing tank, mixed with stirring, and further filtered through a membrane filter, thereby obtaining an ink composition and a treatment liquid composition in each example. Unless otherwise specified, the numerical values for each component shown in the tables represent % by mass. Additionally, in the tables, the numerical values for each content represent the % by mass of the active component on a solids basis.

The abbreviations used and details of the product components for the treatment liquid composition are as follows.

Acid
Citric acid
Glutaric acid
H₃PO₄ (phosphoric acid)
NaH₂PO₄·H₂O (sodium dihydrogen phosphate monohydrate)

Base
KOH (potassium hydroxide)

Organic Solvent
Glycerin
1,2-hexanediol

Surfactant
SURFYNOL 465 (acetylene glycol; manufactured by Nissin Chemical CO., LTD.)

Water
Pure Water

The abbreviations used and details of the product components for the ink composition are as follows.

Pigment
Bk pigment dispersion: A pigment dispersion prepared by the following method was used.

Resin Particles
HYDRAN WLS-213 (non-crosslinkable polyurethane resin, trade name, manufactured by DIC Corporation)
TAKELAC WS-5984 (resin having a blocked isocyanate group, trade name, manufactured by Mitsui Chemicals, Inc.)
ETERNACOLL UW-1501F (resin having a blocked isocyanate group, trade name, manufactured by UBE Corporation)
TAKELAC WS-4022 (trade name, manufactured by Mitsui Chemicals, Inc.)

Crosslinking Agent
CARBODILITE E-02 (carbodiimide crosslinking agent, trade name, manufactured by Nisshinbo Chemical Inc.)
CARBODILITE E-05 (carbodiimide crosslinking agent, trade name, manufactured by Nisshinbo Chemical Inc.)
MEIKANATE TP-10 (blocked isocyanate crosslinking agent, trade name, manufactured by Meisei Chemical Works, LTD.)
EPOCROS WS-700 (oxazoline crosslinking agent, trade name, manufactured by NIPPON SHOKUBAI CO., LTD.)
EPOCROS K-2010E (oxazoline crosslinking agent, trade name, manufactured by NIPPON SHOKUBAI CO., LTD.)
EPOCROS K-2020E (oxazoline crosslinking agent, trade name, manufactured by NIPPON SHOKUBAI CO., LTD.)
EPOCROS K-2035E (oxazoline crosslinking agent, trade name, manufactured by NIPPON SHOKUBAI CO., LTD.)

Organic Solvent
Glycerin
1,2-hexanediol

Surfactant
SURFYNOL 465 (acetylene glycol; manufactured by Nissin Chemical CO., LTD.)

Base
Triethanolamine

Water
Pure water

### Preparation of Bk Pigment Dispersion

500 g of carbon black primary powder prepared by the furnace method (primary particle diameter=18 nm, BET specific surface area=180 m²/g, and DBP absorption=186 mL/100 g) was added to 3,750 g of ion-exchanged water. This liquid was heated to 45° C. while stirring with a dissolver. While grinding the resulting mixture with a sand mill using zirconia beads having a diameter of 0.8 mm, 30,000 g of an aqueous solution of sodium hypochlorite (available chlorine concentration=12%) was dropwise added at 45° C. over 3.5 hours. After dropwise addition, grinding with the sand mill was continued for a further 30 minutes to obtain a self-dispersible carbon black dispersion. This dispersion was filtered through a wire mesh having a pore size of 400 μm to remove the zirconia beads and unreacted carbon black. A 5% aqueous solution of potassium hydroxide was then added to the filtrate to adjust the pH to 7.5, followed by desalting and purification using an ultrafiltration membrane until the conductivity of the dispersion reached 1.5 mS/cm. Consequently, further desalting and purification were performed using an electrodialysis device until the liquid conductivity reached 1.0 mS/cm. After purification, the treatment liquid was concentrated until the concentration of the self-dispersible carbon black reached 17% by mass. The resulting concentrate was subjected to centrifugation to remove coarse particles and then filtered through a 0.6 μm filter. Consequently, ion-exchanged water was added to the filtered concentrate to dilute the concentrate until the concentration of the self-dispersible carbon black reached 15% by mass, thereby obtaining the Bk pigment dispersion.

### 2. Printing Method

Using a device modified from an ML-8000 printer (trade Name, Manufactured by Seiko Epson Corporation), printing was performed on a white broadcloth of 100% cotton (#4000, manufactured by Nisshinbo Chemical Inc.) and on a polyester fabric by ejecting the treatment liquid composition and the ink composition from the head within the same pass. For the same scan region, the main scan was performed a plurality of times (2, 4, 8, 12, or 16 passes) to form a solid pattern image of 20 cm ×5 cm on the fabric serving as the recording medium. After image formation, heating is performed in an oven at 160° C. for 5 minutes to dry, thereby producing the recorded matters of Examples and Comparative Examples. The ink compositions, treatment liquid compositions, and their deposited amounts are shown in Tables 4 to 7. The term “solid pattern image” means an image in which dots are uniformly formed over the entire recording region (main scanning direction×sub-scanning direction: 20 cm×5 cm) such that the applied amount of each liquid reaches the above-described numerical value. As the ink jet head unit, a head unit is used in which a nozzle pitch is 600 dpi in the sub-scanning direction, with two head chips disposed in the sub-scanning direction to provide a nozzle length of 2 inches.

### 3. Evaluation Method

### 3.1. Wet Rubbing Fastness

For the recorded matters obtained by the above-described printing method, a Crockmeter FI-306 (trade name, manufactured by TESTER SANGYO CO., LTD.) was used to rub the image of the recorded matter 10 times under a load of 9 N with bleached cotton cloth. Subsequently, in the region of the bleached cotton cloth that is contaminated by the ink, the optical density (hereinafter, also referred to as “OD”) of black of the printed image was measured at Status E using an FD-7 spectrodensitometer (trade name, manufactured by Konica Minolta, Inc.), and the results were rated according to the following criteria.

When the recorded matter on the cotton fabric is rated A or better and the recorded matter on the polyester fabric is rated B or better, it can be said that a particularly good effect is obtained.

Evaluation Criteria
SS: Black OD is 0.18 or less
S: Black OD is greater than 0.18 and less than or equal to 0.25
A: Black OD is greater than 0.25 and less than or equal to 0.32
B: Black OD is greater than 0.32 and less than or equal to 0.40
C: Black OD is greater than 0.40

### 3.2. Hand of Recorded Matter

The hand of the recorded matter obtained by the above-described printing method was rated by a sensory evaluation. Specifically, five panelists were asked to touch the recorded matters and choose one of the following: “no perceptible difference from the inherent hand of the fabric” or “the printed fabric is stiff and the inherent hand of the fabric is impaired”, and the results were rated according to the criteria below.

Note that even a C rating was acceptable for practical use.

Evaluation Criteria
S: Five panelists answered “no perceptible difference from the inherent hand of the fabric”
A: At least three but fewer than five panelists answered “no perceptible difference from the inherent hand of the fabric”
B: At least one but fewer than three panelists answered “no perceptible difference from the inherent hand of the fabric”
C: Zero panelists answered “no perceptible difference from the inherent hand of the fabric”

### 4. Evaluation Results

From Tables 1 to 6, it is apparent that, when using an ink jet composition set including a treatment liquid composition and a first ink composition, in which the treatment liquid composition contains an acid serving as a flocculating agent that flocculates components in the first ink composition and water, and the first ink composition contains a crosslinking agent having a crosslinkable group and/or resin particles having a crosslinkable group, a base, and water, the resulting recorded matter exhibits excellent wet rubbing fastness and hand.

What is claimed is:

1. An ink jet composition set comprising:
a treatment liquid composition; and
a first ink composition, wherein
the treatment liquid composition contains an acid serving as a flocculating agent that flocculates components in the first ink composition, and water, and
the first ink composition contains a crosslinking agent having a crosslinkable group and/or resin particles having a crosslinkable group, a base, and water.

2. The ink jet composition set according to claim 1, wherein
the first ink composition contains resin particles having no crosslinkable group.

3. The ink jet composition set according to claim 1, wherein
the first ink composition is a colored ink in which a content of a colorant is greater than 0.1% by mass with respect to a total amount of the first ink composition.

4. The ink jet composition set according to claim 1, wherein
the first ink composition is a clear ink in which a content of a colorant is 0.1% by mass or less with respect to a total amount of the first ink composition.

5. The ink jet composition set according to claim 1, further comprising:
a second ink composition, wherein
the second ink composition contains a colorant, resin particles, a base, and water.

6. The ink jet composition set according to claim 5, wherein
the second ink composition further contains a crosslinking agent having a crosslinkable group.

7. The ink jet composition set according to claim 3, wherein
a total content of a resin component in the first ink composition is 3% to 8% by mass with respect to the total amount of the first ink composition.

8. The ink jet composition set according to claim 4, wherein
a total content of a resin component in the first ink composition is 5% to 15% by mass with respect to the total amount of the first ink composition.

9. The ink jet composition set according to claim 1, wherein
the crosslinking agent contains one or more selected from the group consisting of an oxazoline crosslinking agent, a carbodiimide crosslinking agent, and a blocked isocyanate crosslinking agent.

10. An ink jet recording method comprising:
a treatment liquid depositing step of ejecting a treatment liquid composition by an ink jet method to deposit the treatment liquid composition on a fabric; and
a first ink depositing step of ejecting a first ink composition by an ink jet method to deposit the first ink composition on the fabric, wherein
the treatment liquid composition contains an acid serving as a flocculating agent that flocculates components in the first ink composition, and water, and
the first ink composition contains a crosslinking agent having a crosslinkable group and/or resin particles having a crosslinkable group, a base, and water.

11. The ink jet recording method according to claim 10, wherein
a deposited amount I0 of the first ink composition in the first ink depositing step is 15 to 70 g/m².

12. The ink jet recording method according to claim 10, further comprising:
a second ink depositing step of ejecting a second ink composition by an ink jet method to deposit the second ink composition on the fabric, wherein
the second ink composition contains a colorant, resin particles, a base, and water.

13. The ink jet recording method according to claim 12, wherein
a deposited amount I1 of the second ink composition in the second ink depositing step is 10 to 50 g/m².

14. An ink jet recording apparatus comprising:
an ink jet head that ejects a liquid by an ink jet method to deposit the liquid on a fabric; and
a control section that controls ejection of the liquid, wherein
the control section executes
a treatment liquid depositing step of ejecting a treatment liquid composition by an ink jet method to deposit the treatment liquid composition on a fabric, and
a first ink depositing step of ejecting a first ink composition by an ink jet method to deposit the first ink composition on the fabric,
the treatment liquid composition contains an acid serving as a flocculating agent that flocculates components in the first ink composition, and water, and
the first ink composition contains a crosslinking agent having a crosslinkable group and/or resin particles having a crosslinkable group, a base, and water.

15. The ink jet recording apparatus according to claim 14, wherein
the control section varies a deposited amount of the first ink composition on the fabric according to a type of fabric.
